(19) United States
(12) Patent Application Publication
(10) Pub. No.: US 2009/0044641 A1
(43) Pub. Date: Feb. 19, 2009

(54) TRACE SAMPLER

(75) Inventors: Ravi K. Konduri, Heathrow, FL (US); Edward E.A. Bromberg, Orlando, FL (US); John M. Oelschlaeger, Palm Harbor, FL (US); Eric Moy, Orlando, FL (US); Mark Fraser, Nashua, NH (US)

Correspondence Address: FISH & RICHARDSON P.C., P.O. BOX 1022, MINNEAPOLIS, MN, 55440-1022, US

(73) Assignee: L-3 Communications CyTerra Corporation, Orlando, FL (US)

(21) Appl. No.: 12/192,694

(22) Filed: Aug. 15, 2008

Related U.S. Application Data
(60) Provisional application No. 60/956,096, filed on Aug. 15, 2007.

(51) Int. Cl. G01N 1/10

(52) U.S. Cl. 73/863.11; 73/864.33; 73/864.73

(57) ABSTRACT

A position of an object moving through a region of interest is determined, and at least one source of an air stream is selectively activated based on the determined position. The air stream is capable of dislodging a particle from the object moving through the region of interest. The air stream is directed toward the region of interest. An air collector is selectively activated, based on the determined position, to draw air from the region of interest. The drawn air is deposited on a sample collector, and the sample collector is analyzed to determine whether the deposition of the air stream left particles of a material of interest on the sample collector.

### CROSS-REFERENCE TO RELATED APPLICATION

This application claims priority to U.S. Provisional Application Ser. No. 60/956,096, titled LOWER BODY SAMPLER, and filed on Aug. 15, 2007, which is incorporated by reference in its entirety.

### TECHNICAL FIELD

This description relates to a lower body sampler.

### BACKGROUND

Particles may be collected from a region along with a relatively large volume of ambient air. The presence of the large volume of ambient air may present challenges to detecting and analyzing the collected particles.

### SUMMARY

In one general aspect, a system includes air sources each configured to direct a stream of air during a sampling period, the directed stream of air being capable of dislodging a particle from an object while the object is moving through a region of interest, and restrict the stream of air during a restricting period, air collectors configured to collect air from the region of interest, and a sensor configured to output an indication of a position of the moving object. The system also includes a processor configured to determine, based on the output indication, a relative position of the moving object with respect to the region of interest, and activate fewer than all of the air sources or fewer than all of the air collectors based on the determined position of the moving object with respect to the region of interest.

Implementations may include one or more of the following features. The air sources may be configured to direct the stream of air toward the region of interest. A conduit may be coupled to the air collectors and configured to deposit collected air onto a sample collector. The conduit may include a pipe having a smooth inner surface. A housing including first and second pedestals may be included, and the region of interest may be defined between the first and second pedestals. A detection apparatus configured to analyze the sample collector for the presence of particles having characteristics of materials of interest may be included. The detection apparatus may be configured to heat the sample collector, sense thermal energy released from the sample collector while the sample collector is heated, determine a thermal signature of the sample collector based on the sensed thermal energy, and analyze the thermal signature for characteristics of explosive materials.

A second sensor configured to output an indication of a size of the moving object may be included, and the processor may be further configured to determine the size of the moving object based on the indication of the size of the moving object, and activate fewer than all of the air sources or fewer than all of the air collectors based on the determined size of the moving object.

The indication of position of the moving object may include an indication of a speed of the moving object, and the processor may be further configured to determine the speed of the moving object based on the indication of the speed of the moving object, and to activate fewer than all of the air sources or fewer than all of the air collectors based on the speed of the moving object. The object may move through the region of interest in a direction transverse to a normal of a surface of the first or second housing pedestals that is adjacent to the region of interest. The moving object may be a person, and the region of interest may include a volume encompassing a lower portion of the person. The lower portion of the person may include a portion of the person below a knee. The first housing pedestal may enclose the air sources, the air sources may be close coupled to the region of interest, and the first housing may include an opening through which an air stream is directed. The second housing pedestal may enclose the air collectors, the conduit, and the detection apparatus. The second housing may be on an opposite side of the region of interest from the first housing, the air collectors may be close coupled to the region of interest, and the second housing may include an opening through which air is received by the air collectors.

A flow device may be coupled to each of the air sources. The flow device may be configured to direct an air stream from an air source toward the region of interest when opened and restrict the air stream when closed, and opening the flow device may activate the air source. A flow device may be coupled to each of the air collectors. The flow device may be configured to pass air through an air collector when opened and prevent air from flowing when closed, and opening the flow device may activate the air collector.

The air collectors may be configured to receive air from the region of interest only during a sampling period. The air sources may be arranged in a two-dimensional array of air sources close coupled to the region of interest, and the air collectors may be arranged in a two-dimensional array of air collectors close coupled to the region of interest. The air collectors may be configured to draw air through a suction force.

In another general aspect, a position of an object moving through a region of interest is determined, and at least one source of an air stream is selectively activated based on the determined position. The air stream is capable of dislodging a particle from the object moving through the region of interest. The air stream is directed toward the region of interest. An air collector is selectively activated, based on the determined position, to draw air from the region of interest. The drawn air is deposited on a sample collector, and the sample collector is analyzed to determine whether the deposition of the air stream left particles of a material of interest on the sample collector.

Implementations may include one or more of the follow features. The object in the region of interest may include a lower leg and foot of a person. Analyzing the sample collector to determine whether the deposition of the air stream left particles of a material of interest on the sample collector may include heating the sample collector, sensing thermal energy released from the sample collector while the sample collector is heated, determining a thermal signature of the sample collector based on the sensed thermal energy, and analyzing the thermal signature for characteristics of explosive materials.

Implementations of the techniques discussed above may include a method, a process, a system or an apparatus. The details of one or more of the implementations are set forth in the accompanying drawings and description below. Other features will be apparent from the description and drawings, and from the claims.

### DESCRIPTION OF THE FIGURES

FIG. 1A illustrates an example of a system for screening a person for the presence of a material of interest.

FIGS. 1B, 2A, and 2B illustrate top views of an example system for screening a person for the presence of a material of interest.

FIGS. 3 and 4 illustrate a front view of an example system for screening a person for the presence of a material of interest.

FIG. 5 is a block diagram of an example system for screening a person for the presence of a material of interest.

FIG. 6 is a block diagram of an air source system.

FIG. 7 is a block diagram of an air collection system.

FIG. 8 is an illustration of an impact collector.

FIGS. 9A-9C illustrate an example of a collection and detection system.

FIG. 10 illustrates an example system for detecting explosives.

FIG. 11 shows an example process for collecting particles from a region of interest.

FIG. 12 illustrates an example of a system for screening a person for the presence of particles of a material of interest.

### DETAILED DESCRIPTION

Particles are dislodged from the body of person who walks through a detection system by directing streams of pressurized air (air knifes) toward the person and collecting air that includes the dislodged particles. The dislodged particles are analyzed to determine whether they are particles of a hazardous substance, such as explosives. In order reduce the dilution of collected air with ambient air, which may be unlikely to include a dislodged particle, the collection of the air may be selectively controlled based on the motion of the person as the person walks through the detection system. In particular, the detection system includes multiple sources of air knifes and multiple air collectors, and the sources and collectors are staggered, sequenced, or controlled such that only the sources that contribute to the dislodging of particles and the collectors that collect air likely to include a dislodged particles are activated at a given time.

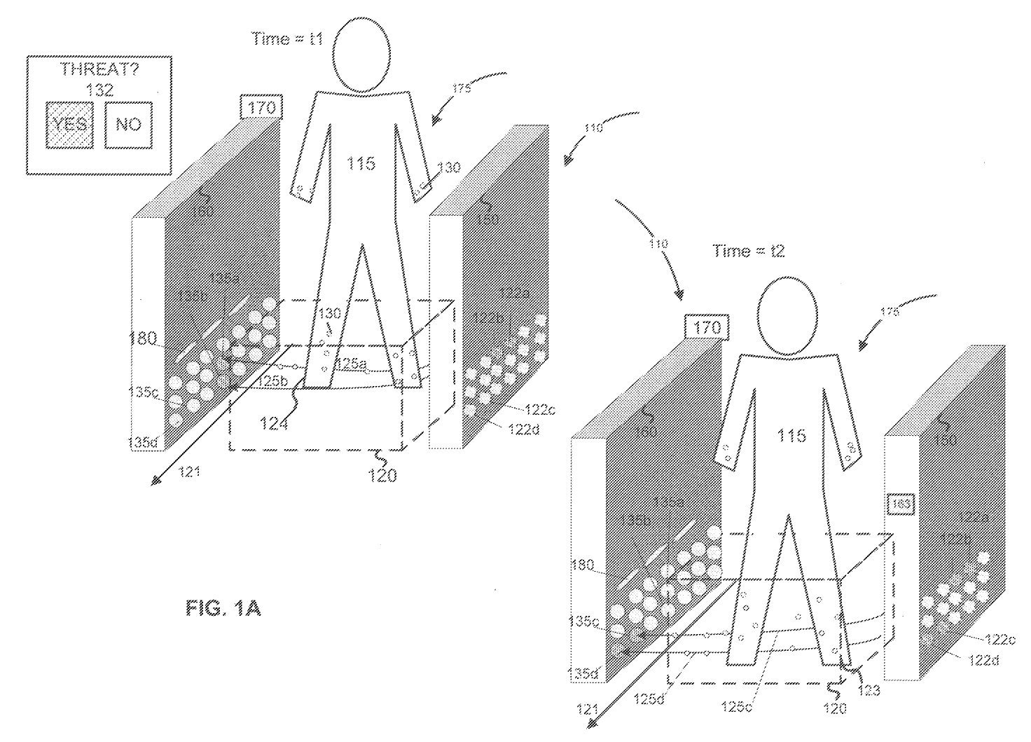

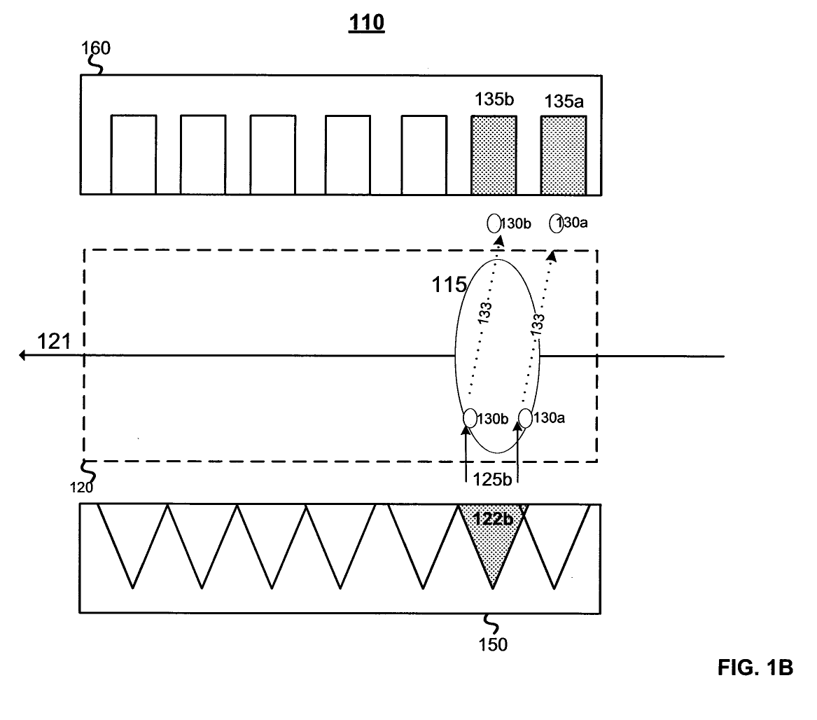

Referring to FIG. 1A, a system 110 for screening a person 115 for the presence of particles or residues of materials of interest as the person moves through the system 110 is shown. Air sources included in the system 110 direct air streams (which may be referred to as air knives) toward the person 115 to dislodge particles (such as the particle 130) on the person 115, the clothing of the person 115, the shoes of the person 115, or items carried by the person 115. The dislodged particles are collected by air collectors, and the particles are analyzed to determine whether the particles are particles of a material of interest (such as an explosive). The system 110 may be used to screen the lower portion of the body of the person 115, such as the portion of the body below the knees, without the person 115 having to stop to, for example, take of their shoes. Although the example shown in FIG. 1A shows a lower portion of the body of the person 115 being screened, in other examples, additional or other portions of the body of the person may be sampled. For example, the hand and torso regions of the person 115 may be sampled simultaneously with the sampling of the lower portions of the person 115.

The system 110 includes multiple air sources (such as the air sources 122a-122d) that release air streams (such as air streams 125a-125d) when activated, and multiple air collectors (such as air collectors 135a-135d) that, when activated, draw air from the region surrounding the air collector. The air collected by all of the activated air collectors may be referred to as the sample volume of air. Because the air collected by the air collectors includes air that originated from an air source as well as ambient air that is unlikely to include dislodged particles, activating all of the air collectors results in a sample volume of air that has a high proportion of ambient air unlikely to include dislodged particles. As a result, the air that includes dislodged particles becomes diluted with the ambient air, which results in decreased performance of the system 110 because fewer particles are included in a given volume of collected air. Having fewer particles results in a decreased signal-to-noise ratio when analyzing the particles to determine whether the particles are particles of a material of interest, a lower probability of detection, and a greater amount of false positives.

However, by activating only those air sources that are most likely to strike the person 115 as the person 115 moves through the region of interest, and activating air collectors that are most likely to collect air that includes dislodged particles, the dilution of the air that includes dislodged particles is reduced. For example, the position of the person 115 may be determined relative to the region of interest 120. The air sources that are most likely to release air streams that strike the person 115 are activated based on the determined position of the person 115, and the air collectors that are most likely to collect particles dislodged from the person 115 are activated based on the position of the person 115. Thus, as the person 115 moves through the region of interest 120, different air collectors and air sources are activated. By selectively activating air sources and air collectors, dislodged particles are collected during the entire time the person 115 passes through the region of interest 120 (resulting in more particles being collected) and the sample volume remains low (resulting in less dilution of the air that includes dislodged particles).

The region of interest 120 may extend from just above a surface on which the system 110 is placed up to a distance above the surface where a knee region of an average person would be located (e.g., about 45 centimeters above the surface). Thus, the system 110 may be used to screen a lower portion of a body of the person 115, including shoes or footwear, for the presence of materials of interest. Moreover, the system 110 may be used to screen other portions of the body of the person 115. Additionally, because the system 110 screens the person 115 as the person 115 moves through the system 110, the person 115 does not have to stop to be screened, nor does the person 115 have to remove their shoes.

The system 110 may be placed at a location in which people and objects (such as luggage and packages) are screened by the system 110 prior to being allowed to pass to a secured area. For example, the system 110 may be placed at a security checkpoint in an airport or other transportation hub, or the system 110 may be placed at the entrance to a government building. The system 110 may be placed outside, for example, the system may be placed at an entrance to a stadium or other public gathering place. In order to allow persons and objects to be screened and quickly move to the secured area with a minimum amount of inconvenience, the system 110 processes a relatively large volume of persons and objects. For example, the system 110 may process twelve persons or more per minute. The number of persons that the system 110 may process in a given amount of time is ultimately limited by the speed at which the persons are able progress through the system given other time constraints often faced while traveling. For example, the system 110 may be located at an airport, and persons passing though the system 110 may have to first pass through a checkpoint where their boarding passes are examined by a clerk at a rate of two passengers per minute. Thus, only two passengers would pass through the system 110 per minute even though the system 110 is able to process passengers at a faster rate.

The system 110 includes air sources (such as the air sources 122a-122d) that direct air streams (such as the air streams 125a-125d) toward the region of interest to dislodge particles 130 from the person 115. Air collectors (such as the air collectors 135a-135d) collect air and any dislodged particles. The dislodged particles are analyzed to determine whether the particles are particles of a material of interest. The materials of interest may include hazardous and/or contraband materials such as exothermic compounds, narcotics, controlled substances, illicit drugs, biological agents, organic matter (such as foodstuffs and plants), hazardous chemicals, chemical and/or biological warfare agents, and materials that may be made into hazardous and/or contraband material when combined with other materials. Exothermic compounds may include military-grade explosives, commercial explosives, plastic explosives, and homemade explosives. Some of the exothermic compounds may be made up, at least partially, of crystalline particles.

The presence of particles and residues of a material of interest on the person 115 may indicate that the person 115 poses a threat. Persons who handle explosives, controlled substances, narcotics, or other materials of interest tend to become contaminated with trace residues of the materials. For example, the example shown in FIG. 1A, the hand and foot regions of the person 115 are contaminated by particles 130, which are particles of an explosive material. The person 115 may have become contaminated with the particles by grasping a bomb made of explosive materials. The explosive materials that make up the bomb include crystalline particles, and other trace residues, that are transferred from the bomb to the hand of the person 115 and remain on the hand even after the person 115 releases the bomb. Thus, when the person 115 touches other objects, such as clothing, shoes, luggage, and packages, the crystalline particles 130 and other trace residues are transferred from the hand to the object. Additionally, the particles 130 and other trace residues may remain on the hand of the person 115 even after the hand is washed or rubbed, for example, with a towel or on clothing.

The amount of time that the particles 130 from the bomb remain on the hand of the person 115, or objects that the person 115 touches, varies depending on the type of material from which the object is made and the volatility of the explosive material included in the bomb. For example, some plastic explosives may include plasticizers that make the particles stick more readily to objects, and such particles may remain on the object for months. In contrast, particles of volatile compounds may remain on objects for less than one hour. However, particles of most explosives remain on the object even after attempts to remove the particles from the object. Thus, by dislodging particles from the person 115 and analyzing the particles, the system 110 may determine that the person 115 is contaminated with particles of a material of interest and flag the person 115 as a potential or actual threat.

The system 110 also includes a display 132 that is in communication with the system 110 and that indicates whether materials of interest are present on the person 115. The system 110 also includes a first housing 150 and a second housing 160, both of which may be close coupled to the region of interest 120. The air sources (such as the air sources 122a-122d) and air collectors (such as the air collectors 135a-135d) are closed coupled to the region of interest 120. In some implementations, the air sources and the air collectors are close coupled to the region of interest 120 by shaping a surface of the first housing 150 and the second housing 160 to be similar to the shape of a typical person, thus also bringing the air sources and the air collectors closer to the person 115 and the region of interest 120. For example, the inner surface of the first housing 150 may be closer to the second housing 160 at the base than in the middle because most people are wider in the waist region than in the lower body region. The air sources and air collectors are adjacent to the region of interest 120.

The first housing 150 includes the air sources 122a-122d, which are the source of the air streams 125a-125d. In the example of FIG. 1A, the air sources are shown as dotted lines to indicate that the air sources are on an surface of the housing 150 adjacent to the region of interest 120. The second housing 160 includes the air collectors 135a-135d. The first housing 150 may enclose a controller or a processor 163 to control the provision of the air streams 125a-125d toward the region of interest 120. For example, first housing 150 may include multiple air sources, and the processor 163 may determine which of the air sources are activated to emit an air stream. The processor 163 may define a period during which the air sources emit the air stream and/or a time at which the air sources are activated to emit air.

As discussed above, the system 110 directs the air streams 125a-125d such that the air streams 125a-125d are sequenced or staggered to be directed toward particular portions of the region of interest 120. For example, the air streams 125a-125d may be sequenced or staggered to target the person 115 as the person 115 moves along the direction 121 by providing air in bursts at locations within the region of interest 120 where the person 115 is located. Additionally, the air collectors 135a-135d may be synchronized, matched, or optimized with the air sources 122a-122d to increase the proportion of collected air that originates from the air sources 122a-122d. For example, the air collectors 135a-135d may be controlled such that the air collectors 135a-135d only draw air from the region of interest 120 while at least one of the air sources 122a-122d direct an air stream toward the region of interest 120.

The air collectors may be arranged in a two-dimensional or one-dimensional array along the region of interest such that the air collectors sample air from multiple locations of the region of interest 120. Sampling air from multiple locations of the region of interest 120 may increase the chance of receiving a dislodged particle at an air collector. Referring to FIG. 1B, the air stream 125b, which originated from the air source 122b, is shown dislodging the particles 130a and 130b from the person 115. The shearing force of the air stream 125b dislodges the particles 130a and 130b from the person 115, and the particles 130a and 130b are deflected along a direction 133 and are received by the air collectors 135a and 135b. The presence of the air collectors 135a and 135b helps to ensure that the particles 130a and 130b are received by an air collector instead of, for example, hitting the wall of the housing 160.

Returning to FIG. 1A, the system 110 also may include a sensor 170 located near an entrance 175 to the system 110 indicates that the person 115 is approaching the system 110. The sensor 170 may be, for example, a proximity sensor, an optical sensor, or a pressure sensor that the person 115 may activate by stepping on. The sensor 170 may be an array of sensors. The sensor 170 may be a turnstile or other movable barrier that is struck as the person 115 enters the system 110. In addition to locating the person 115, and activation of the sensor 170 may trigger activation of one or more of the air sources 122a-122d. Data from the sensor 170 may be used to estimate a height and/or size of the person 115 and the distance between the knees of the person 115 and the floor. Thus, the air sources may be activated such that the lower leg region of the person 115 is targeted even if the person 115 is not of average height and build.

Additionally, one or more sensors 180 are located along the region of interest 120 to track the person 115 as the person 115 moves through the region of interest 120 along the direction 121. The sources 122a-122d to generate the air streams 125a-125d may be selected such that the air streams 125a-125d are directed to a portion of the region of interest where the person 115 is located as indicated by data collected by the sensors 180.

For example, as shown in FIG. 1A, at the time “t1,” the person 115 is at the location 124 within the region of interest 120. Because the person 115 is located at the location 124, the air sources 122a and 122b, which are near the location 124, are activated to direct the air streams 125a and 125b (which also may be referred to as air knifes 125a and 125d) toward the region of interest 120 to dislodge particles 130 from the person 115. The air collectors 135a and 135b are activated to collect air. The air collectors 135a and 135b collect air that includes ambient air from the region of interest 120 and air that includes the dislodged particles 130. The air collectors 135a and 135b are activated because the position of the air collectors 135a and 135b makes it most likely that the air collectors 135a and 135b collect the dislodged particles. Thus, even though the air collectors 135a and 135b collect ambient air, activating only the air collectors 135a and 135b increases the proportion of collected air that originates from the air sources 122a and 122b (which is more likely than ambient air to include dislodged particles). Increasing the proportion of air that originates from the air sources 122a and 122b may also be considered as minimizing the dilution of the air originating from the air sources 122a and 122b with ambient air that is present in the region of interest 120.

At the time “t2,” the person has moved through the region of interest 120 to the position 123. The position 123 of the person 115 is determined, and the air sources 122c and 122d are activated rather than the air sources 122a and 122b. The air collectors 135c and 135d are activated because the position of the air collectors 135c and 135d makes it most likely that the air collectors 135c and 135d collect dislodged particles.

Thus, the system 110 includes multiple air sources that produce air streams that dislodge particles from the person 115 as the person moves through the system in the direction 121. By selectively activating some of the air sources to release air streams and selecting fewer than all of the air collectors to draw air, the system 110 is able to sample the air throughout the region of interest 120 most likely to include the dislodged particles while also maintaining a low air sample volume.

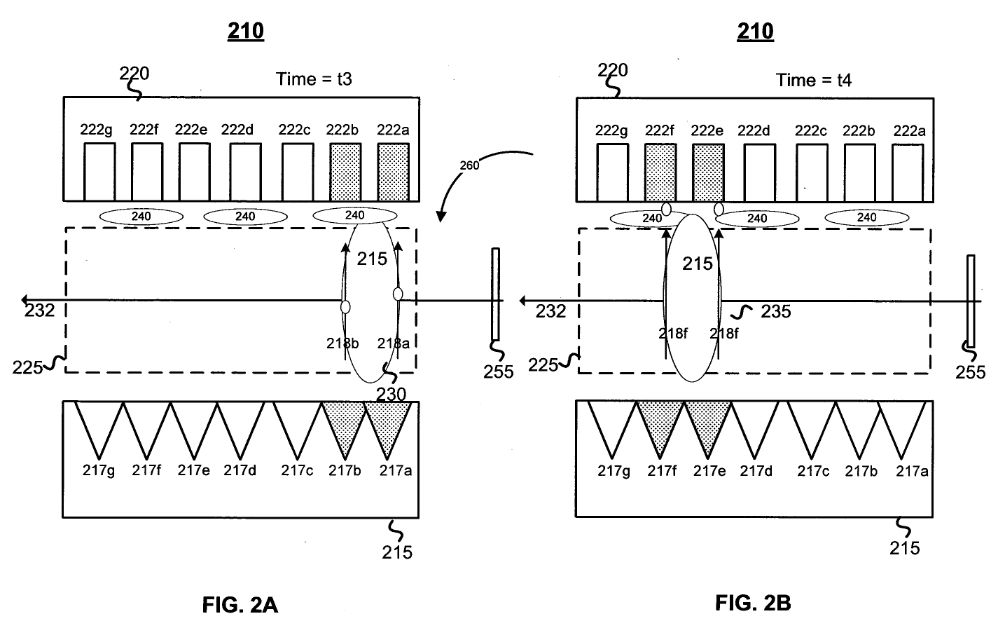

Referring to FIGS. 2A and 2B, a top view of a system 210 is shown as a person 215 moves through the system 210 by traversing a region of interest 225. Air sources and air collectors are selectively activated to follow the person 215 through the region of interest 225. As discussed above, the selective activation of the air sources and air collectors reduces the sample volume and improves performance of the system 210.

The system 210 may be similar to the system 110 discussed above with respect to FIG. 1A. Similar to the system 110, the system 210 includes a first housing 215 and a second housing 220, both of which are adjacent to a region of interest 225 and on opposite sides of the region of interest 225. The first housing 215 includes air sources 217a-217g, which produce air streams 218a-218g when activated. The second housing 220 includes air collectors 222a-222g, which receive air from the region of interest 225 when activated. More or fewer air sources and air collectors may be included than what is shown in the example of FIGS. 2A and 2B. Additionally, the system 210 may include a different number of air sources than the number of air collectors.

Sensors 240, which may be similar to the sensors 180 discussed above with respect to FIG. 1A, may be placed along the region of interest 225 to track the location of the person 215. The sensors 240 are placed such that the sensors 240 do not interfere with the air sources 217a-217g, the air collectors 222a-222g, or the motion of the person 215. For example, the sensors 240 may be pressure sensors that are placed in the floor along the region of interest 225. In a second example, the sensors 240 may be optical sensors placed such that the sensors 240 are included with the first housing 215 and/or the second housing 220. For example, the sensors 240 may be flush with the first housing 215 and/or the second housing 220, or the sensors 240 may be recessed into the first housing 215 and/or the second housing 220. In examples that include an optical sensor, the optical sensor may include a light-emitting diode (LED) mounted on the second housing 220 and a reflector mounted on the first housing 215. List from the LED is incident on the reflector and reflected to a receiver mounted on the second housing 220. In another example, the sensors 240 may be located above the system 210. Although three sensors 240 are shown in the example of FIGS. 2A and 2B, more or fewer sensors 240 may be used. Additionally, a sensor 255 may be placed at or near an entrance 260 to the system 210. The presence of the person 215 may be detected by the sensor 255 and used to activate the air sources 217a-217g.

FIG. 2A shows the system 210 at a time “t3” when the person 215 is at a location 230 within the region of interest 225, and FIG. 2B shows the system 210 at a time “t4” when the person 215 has moved along the direction 232 to the location 235 within the region of interest 225. In the example shown in FIGS. 2A and 2B, the system 210 includes multiple air sources 217a-217g and multiple air collectors 222a-222g, and the activation of the air sources 217a-217g and the air collectors 222a-222g is individually controllable. The presence of multiple air collectors 222a-222g may improve the performance of the system 210 by allowing more particles to be collected. For example, the air stream 218a may strike the person 215 within the region of interest 225 and dislodge a particle. After being dislodged, the particle may be deflected off of the person 215 again or off part of the system 210. The inclusion of multiple air collectors 222a-222g increases the effective surface area of the air collectors, and improves the possibility that the deflected dislodged particle is received by one of the air collectors 222a-222g.

The air sources 217a-217g and the air collectors 222a-222g may be selectively activated, staggered, or sequenced in a manner that reduces the dilution of air that includes dislodged particles. In some implementations, each of the multiple air sources 217a-217g correspond to one of the air collectors 222a-222g. Each of the air sources 217a-217g generates a corresponding air stream 218a-218g when activated. For example, in the example shown in FIG. 2A, the air sources 217a-217g are controlled such that the air sources near the entrance 260 to the region of interest 225 (such as the air sources 217a and 217b) emit air streams (such as the air streams 218a and 218b) immediately after the sensor 255 indicates that the person 215 is near the region of interest 225. Immediately after the sensor 255 is triggered, the person 215 is positioned at a position 230 that is near the entrance 260. Thus, activating the sources 217a and 217b to emit the air streams 218a and 219b immediately after the sensor 255 is triggered as opposed to activating sources further from the entrance 260 (such as the sources 217d and 1217e) increases the amount of air that strikes the person 215 to dislodge a particle. Additionally, the speed of the person 115 may be estimated as, for example, “slow” or “fast” using a sensor such as the sensor 170. Activation of the air collectors and air sources may be based on the speed of the person 215. For example, the time for the person to traverse the region of interest 225 may be estimated before the person 215 enters the region of interest 225, and air collectors and air sources near the far end of the region of interest 225 (such as the air collector 222g and the air source 217g) may be activated at an accordingly appropriate time.

At time “t4,” which may occur a small time (e.g., ones of seconds) after time “t3,” the person 215 has traveled along the direction 232 and is located at a position 235. The air sources 217a-217g may be controlled such that air sources further from the entrance 260 are activated after a time delay consistent with the speed at which the person 215 moves through the region of interest 225. In some implementations, the air sources 217a-217g are controlled based on the position of the person 215 as measured by the sensors 240. In the example shown in FIG. 2B, air sources 217d and 217e may be controlled to be activated after the occurrence of a small (e.g., second or two) time delay that accounts for the movement of the person 215 through the region of interest 225. Because the person 215 is located at the location 235, activating the air sources 217d and 217e results in the air sources 217d and 217e being more likely to strike the person 215 and dislodge a particle from the person 215. Thus, controlling when the sources 217a-217g are activated may allow the air streams 218a-218g to more efficiently dislodge and carry particles from the person 215.

Additionally, the air sources 217a-217g may be controlled such that the air streams 218a-218g are emitted for a particular amount of time, such as two or three seconds per object passing through the region of interest 225. The air collectors 222a-222g may be controlled such that a particular air collector is activated only when a corresponding air source releases an air stream. For example, the air collector 222a may be activated such that the air collector 222a collects air only when the air source 217a emits the air stream 218a. In a second example, one or more other air collectors may be activated when the air stream 218a releases the air stream 218a. For example, as shown in the example of FIG. 1B, air collectors that are not necessarily positioned opposite from the activated air source may be activated to collect dislodged particles only when at least one air source releases an air stream.

Controlling the air collectors 222a-222g may be referred to as synchronizing the air collectors 222a-222g with the sources 217a-217g. Synchronizing the air collectors 222a-222g with the air sources 217a-217g may allow the system 210 to maintain a low air sampling volume while also sampling air from multiple locations within the region of interest 225. For example, if the air source 217a is the only air source activated, and all of the air collectors 222a-222g are activated to receive air, the air collectors 222a-222g may collect particles dislodged from the person 115 along with a large volume of ambient air that is unlikely to include any particles dislodged from the person 215. However, ambient air may include few or no particles and/or the ambient air may include particles that are not of interest such as dirt from the floor. Thus, the amount of particles collected as a portion of the volume of air received is lower when all of the air collectors 222a-222g are activated as opposed to when fewer than all of the air collectors 222a-222g are activated and the amount of particles from materials not of interest is higher.

However, by selectively activating the air collectors 222a-222g during a period in which an air source emits an air stream, the particles received at the activated air collector are more likely to be particles dislodged from the person 215 within the region of interest 225, and, thus, are more likely to be relevant in determining whether the person 215 includes particles of a material of interest. Additionally, the volume of received by the air collectors 222a-222g is lower as a result of fewer than all of the air collectors 222a-222g being activated. Thus, the dilution ratio is lower (e.g., the portion of particles to volume of air received is higher) as compared to the situation when all of the air collectors 222a-222g are activated, which may improve the performance of the system 210. In some examples, 30% to 45% of the air received is air that originated from the sources 217a-217g.

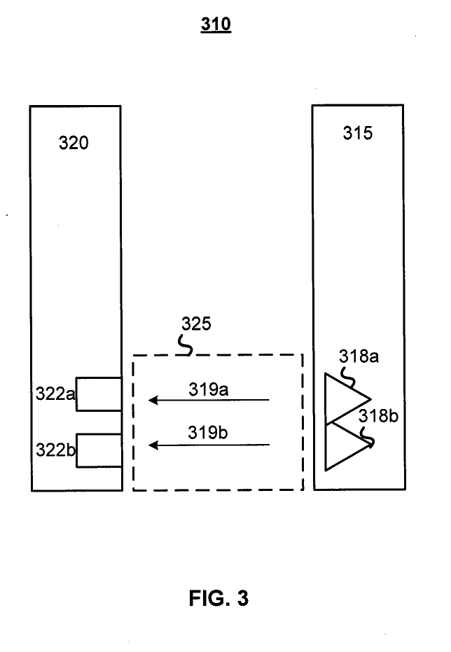

Referring to FIG. 3, a front view of a system 310 is shown. The system 310 may be similar to the systems 110 and 210 discussed above. The system 310 includes a first housing 315 and a second housing 320 that are adjacent to and on opposite sides of a region of interest 325. The first housing 315 includes air sources 318a and 318b, which are arranged vertically along the first housing 315 and which are individually controllable to release air streams 319a and 319b toward the region of interest 325. Air from the region of interest 325 is received by air collectors 322a and 322b. Although two air sources and two air collectors are shown, more or fewer air sources and air collectors may be included. For example, air sources may be placed in a vertical direction on the first housing 315 such that air streams may extend from just above the base of the first housing 315 to about 45 centimeters above the base.

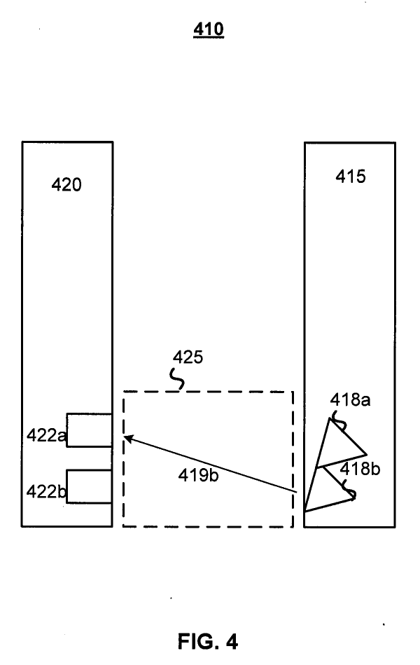

Referring to in FIG. 4, a front view of a system 410 is shown. The system 410 may be may be similar to the systems 110 and 210 discussed above. The system 410 includes a first housing 415 and a second housing 420 that are adjacent to and on opposite sides of a region of interest 425. The first housing 415 includes air sources 418a and 418b, which are arranged vertically along the first housing 415 and which are individually controllable to release air streams 419a and 419b toward the region of interest 425. Additionally, the air sources 418a and 418b may be mounted within the first housing 415 such that the air streams 419a and 419b are also directed upward and toward the region of interest 425. Although two air sources and two air collectors are shown, more or fewer air sources and air collectors may be included.

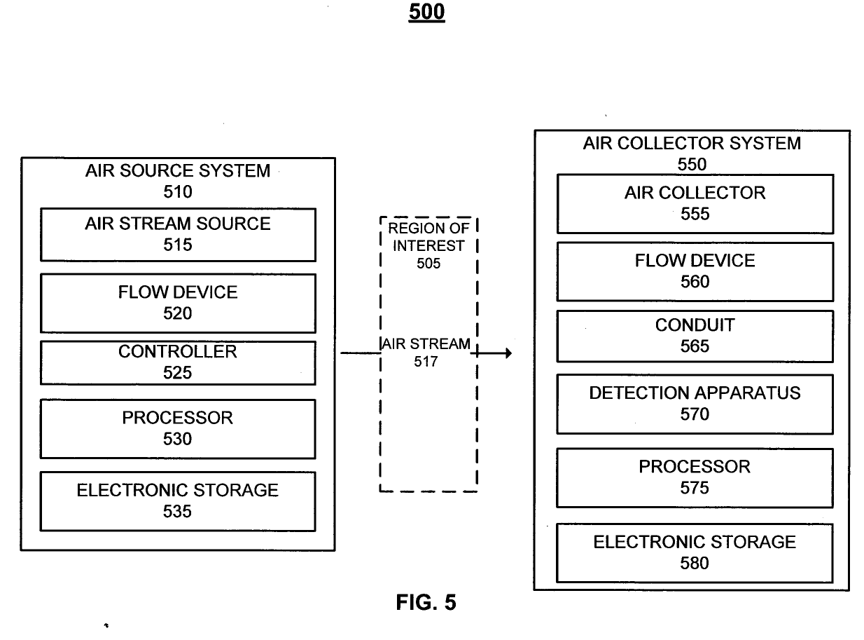

In some implementations, the air sources 418a and 418b may be aimed into a particular air collector. For example, the air source 418a can be positioned such that an air stream produced by the air source 418a propagates parallel to a surface on which the system 410 rests. Thus, both the air stream 419b and the air stream from the air source 418a are directed toward the air collector 422a. Such an arrangement may increase the air collected by the air collector 422a that originates from an air source, which may improve performance of the system 410 by decreasing the dilution of the air collected by the air collector 422a with ambient air that is unlikely to include dislodged particles. Referring to FIG. 5, an example system 500 for collecting particles from a region of interest 505 is shown. The system 500 may be similar to the systems 110, 210, 310, and 410 discussed above. The system 500 includes an air source system 510 that releases air streams (or air knifes) toward the region of interest 505 and an air collector system 550 that collects air from the region of interest 505. The air streams released from the air source system 510 interact with objects within the region of interest 505 to dislodge particles on the objects for later analysis. For example, the system 500 may be used to screen objects within the region of interest to determine whether the objects include particles from a material of interest.

The air source system 510 includes an air stream source 515, an electronic controller 525, a flow device 520, a processor 530, and electronic storage 535. Some or all of the components of the air source system 510 may be enclosed completely or partially within a housing such as the first housing 150 shown in FIG. 1A. The air stream source 515 is configured to provide air for an air stream 517, which also may be referred to as an air knife. The air stream source 515 may be, for example, a compressor that provides compressed air. The air stream source 515 may provide air having a pressure of, for example 40-50 pounds per square inch (psi) at an outlet of the air stream source 515. For example, the air stream source 515 may be coupled through a tubing to a vent, slit, nozzle, aperture, air horn, or other opening in the housing. The opening may be, for example, a slit that is 7.5 centimeters long and 1 millimeter high. The pressure of the air stream 517 from the air stream source at the opening in the housing may be 40-50 psi. However, as the air stream 517 propagates toward the region of interest, the pressure of the air stream 517 decreases such that the air stream 517 retains enough pressure to have a sufficient shearing force to dislodge particles on an object within the region of interest 505, but not so much pressure that the air stream 517 damages the object upon contact or causes discomfort to a person struck by the air stream 517. The air stream 517 produced by the air stream source 515 may have an air flow of, for example, 3 liters of air per second.

The air source system 510 also includes the controller 525 that controls the air stream source 515 and, as discussed below, controls an air collector 555 included in the air collector system 550 such that the air collector 555 is synchronized with the air stream source 515. The controller 525 controls the timing and duration of the air streams (such as the air stream 517) released from the air stream source 515. Thus, the controller 525 determines when the air stream source 515 produces an air stream. In some implementations, the controller 525 also controls the pressure and air flow of the air stream 517 produced by the air stream source 515. To control the air stream provided by the air stream source 515, the controller 525 is coupled to a flow device 520 configured to block, pass, or partially pass air from the air stream source 515. For example, the flow device 520 may be a valve, such as a pinch valve or a solenoid valve. In other implementations, the flow device 520 may be a stem that moves to block the flow of air through the flow device 520 or material that expands to restrict the flow of air from the air stream source 515.

The air source system also includes the processor 530 and the electronic storage 535. The processor 530 may be any type of processor that receives instructions and data from a memory device (such as the electronic storage 535), where the instructions cause the processor to perform one or more actions. For example, the processor 530 may execute instructions stored on the electronic storage 535 to control the flow device 520 through the controller 525 and to control and modify the air stream source, and the processor 530 may be used to start (or “turn on”) the air stream source 515. The processor 530 may be local to the air source system 510; however this is not necessarily the case. For example, in some implementations, the processor 530 may be co-located with the air collector system 550. Although one processor 530 is shown in the example air source system 510 of FIG. 5, in other examples more than one processor may be used.

The electronic storage 535 also may store pre-defined settings for the provision of the air streams from the air stream source 515. For example, the electronic storage 535 may include settings specifying a duration and timing of air streams released by the air stream source. The electronic storage 535 may be a non-volatile or persistent memory. The electronic storage 535 may be volatile memory, such as RAM. In some implementations, the electronic storage 535 may include more than one component, and the more than one component may include both non-volatile and volatile components.

The system 500 also includes the air collector system 550, which receives air from the region of interest 505. The air collector system 550 includes an air collector 555, a flow device 560, conduit 565, a detection apparatus 570, a processor 575, and an electronic storage 580. All or some of the components of the air collector system 550 may be enclosed in a housing such as the second housing 160 discussed above with respect to FIG. 1A. The air collector 555 may be an inlet, vent, aperture, or other opening in the housing at which air from the region of interest 505 is received and through which air from the region of interest 505 flows. In some implementations, the air collector 555 draws air from the region of interest through a vacuum force or a fan. The flow device 560 is a device that is controlled by the controller 525 to allow the air collector 555 to receive air and pass air to the conduit 565. Thus, by controlling the flow device 560, the air collector 555 may be activated to receive air from the region of interest 505 or not receive air from the region of interest 505. By controlling both the flow device 560 and the flow device 520 with the controller 525, the air collector 555 may be synchronized with the air stream source 515 to allow the system 500 to, for example, maintain a low air sampling volume even when multiple air collectors are included in the air collector system 550. The flow device 560 may be, for example, a valve such as an electric solenoid valve. The flow device 560 may be a constriction device, such as a pinch valve, that does not include components within the path of the fluid that passes through the device. Using such a device may prolong the life of the flow device 560 (and also the air collector system 550) because extraneous materials, such as dirt and other debris, are not deposited in the components by the air that flows through the flow device 560. Additionally, valves that have moving parts, or other obstructions, in the region through which air flows may trap particles collected by the air collector 555 and prevent the trapped particles from being analyzed.

The conduit 565 couples the air collector 555 to the detection apparatus 570. The conduit 565 may be, for example, a hollow metal pipe having a smooth inner surface. The smooth inner surface may help prevent particles received from the region of interest 505 from sticking to the inner surface of the conduit 565 which results in more particles reaching the detection apparatus 570 and may result in improved performance. Additionally, using metal as the conduit may prevent electrostatic charge from trapping particles on the surface of the conduit 565 before the particles reach the detection apparatus 570. In implementations in which more than one air collector is included in the air collector system 550, the conduit 565 includes a conduit coupled to each air collector, and the conduits are joined into a single main conduit that directs the received air to the detection apparatus. The conduits are joined at smooth interfaces, for example by spot welding the conduits, to help prevent particles from collecting at the pipe interfaces.

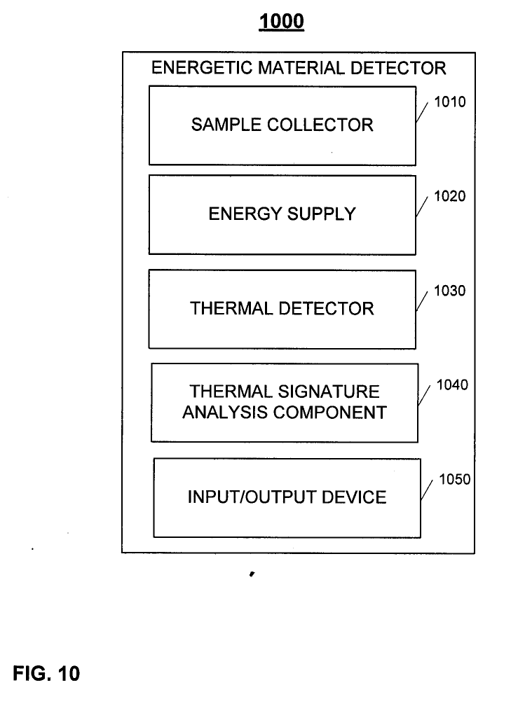

The detection apparatus 570 is a system to determine whether the particles received by the air collector system 555 are particles from a material of interest. For example, the detection apparatus 570 may be a system that determines whether particles are particles of explosive materials by heating the particles and observing the thermal signatures of the energy released by the particles. An example of the detection apparatus 570 is discussed with respect to FIG. 10 below; however, the detection apparatus 570 may be any explosive trace detector system.

The air collector system also includes the processor 575 and the electronic storage 580. The processor 575 may execute instructions to cause the components of the air collection system to perform particular actions. For example, the processor 575 may execute instructions to control the flow device 560 through the controller 525. The electronic storage 580 may store instructions used by the processor 575.

Although the example system 500 includes the processor 530 and the processor 575, in other examples, a single processor may perform the operations performed by the processor 530 and the processor 575. Similarly, a single electronic storage may be used instead of the electronic storage 535 and the processor 575.

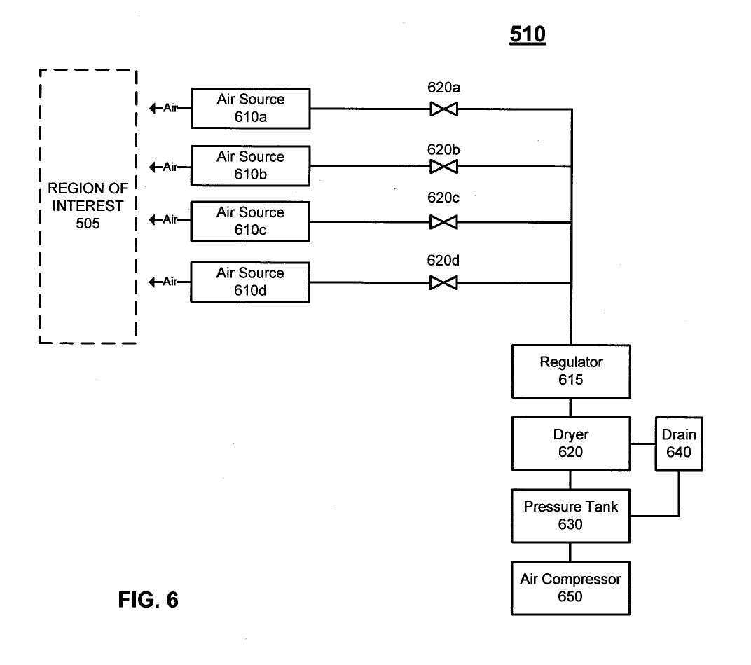

Referring to FIG. 6, an example implementation of the air source system 510 is shown. In the example shown, the air source system 510 includes four air sources, air sources 610a-610d. However, in other examples more or fewer air sources may be included in the air source system 510. Each of the air sources 610a-610d is coupled to a regulator 615 through a valve. In the example shown, the air sources 610a-610d are respectively coupled to valves 620a-620d, which may be similar to the flow device 520. The valves 620a-620d may be different types of flow devices or the valves 620a-620d may all be the same. In some implementations, the valves may be coupled to more than one air source rather than a valve being coupled to one air source. Thus, in these implementations, groups or banks of air sources may be controlled to release or restrict air streams in the same manner at the same time. Air is supplied to the air sources 610a-610b by an air compressor 650, which is coupled to a pressure tank 630. The pressure tank 630 is coupled to a dryer 620, which helps to remove moisture from the air provided by the compressor 650, and a drain 640 to receive the removed moisture.

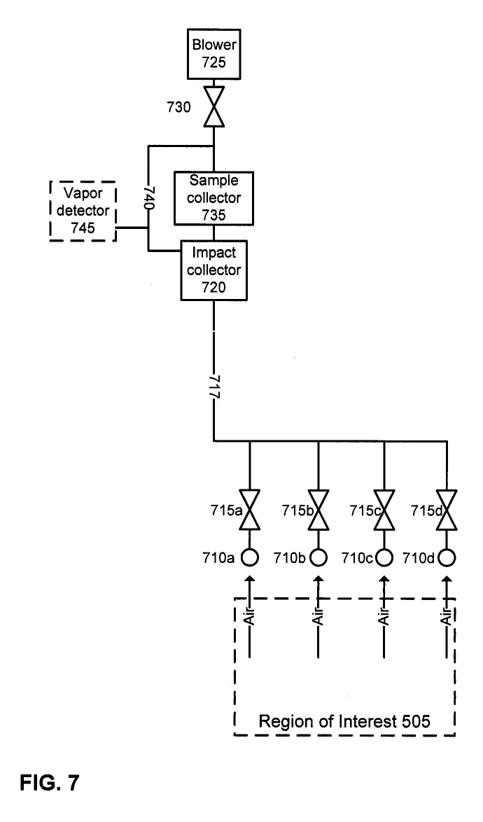

Referring to FIG. 7, an example implementation of the air collector system 550 is shown. In the example shown, the air collector system 550 includes four air collectors 710a-710d. However, in other examples more or fewer air sources may be included in the air collector system 550. The air collectors 710a-710d receive air from the region of interest 505, and the air collectors 710a-710d are coupled to valves 715a-715d. The valves 715a-715d may be similar to the flow device 560. Opening the valves 715a-715d activates the air collectors 710a-710d such that air received by the air collectors 710a-715 flows through a conduit 717 (which may be similar to the conduit 565 discussed with respect to FIG. 5) to an impact collector 720 and deposits particles within the air onto a sample collector 735. A blower 725 provides a suction force that draws air into the collectors 710a-710d. The blower 725 may be a vacuum blower. The blower 725 may include a vacuum motor or a fan. A secondary valve 730 is placed at an inlet to the blower 725 and controls the flow of air into the blower (thus, the valve 730 can be used to turn the flow of air to the blower 725 on and off). Air from the air collectors 710a-710d is drawn through the conduit to the impact collector 720, which may be a metal mesh. Particles carried by the air are deposited on the impact collector 720. Air that is not drawn to the sample collector 735 flows into a bypass line 740. In some implementations, a vapor detector 745 may be coupled to the bypass line 740. The vapor detector 745 allows detection of explosives that have a relatively high vapor pressure.

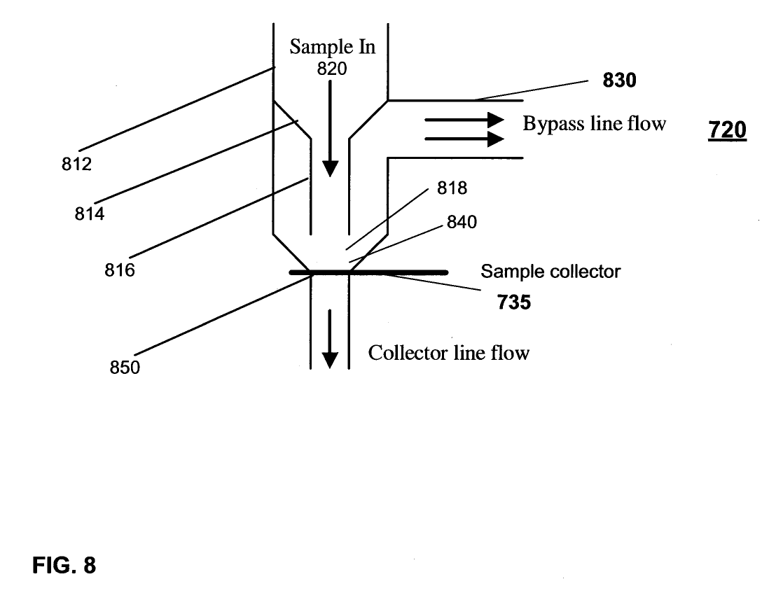

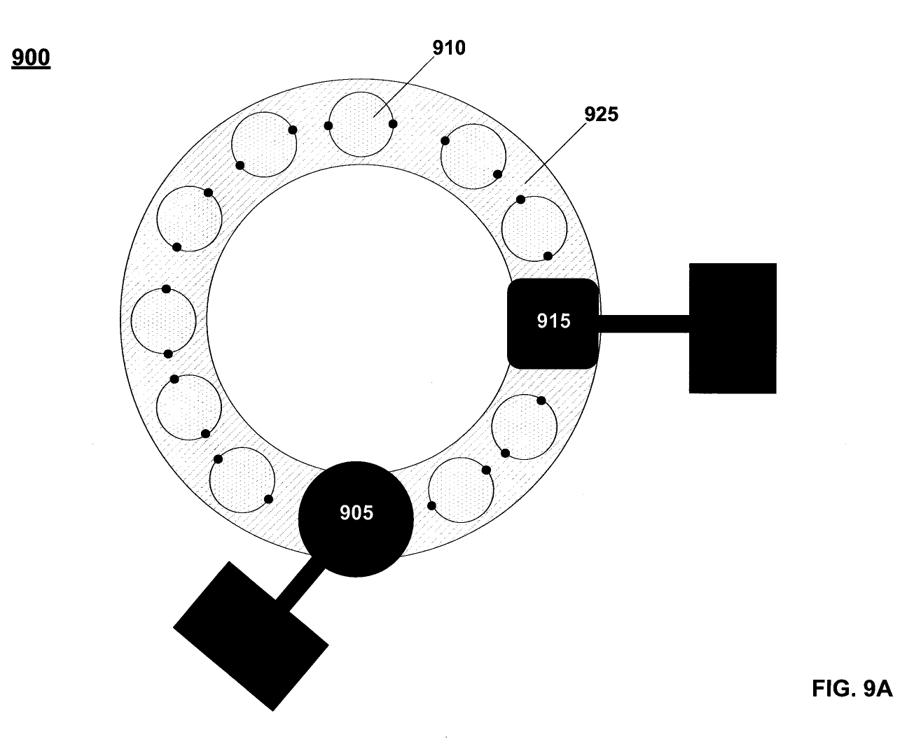

Referring to FIG. 8, the impact collector 720 is shown in greater detail. The impact collector combines the air received at the air collectors 710a-710d that are activated into a single air flow from which particles are collected onto the sample collector 735. The sample collector 735 also may be referred to as a sample media. The air received at the air collectors 710a-710d that travels through the conduit 717 may be referred to as an airflow. At a critical flow rate, particles carried by the airflow remain in the airflow and are carried by the airflow rather than falling out of the airflow and onto the walls of the conduit 717. Loss of particles from the airflow results in a reduction in the amount of particles available for analysis by the detection apparatus 570 and may lead to a false negative. Additionally, loss of particles from the airflow also may cause false positives (e.g., the loss of particles may result in carry over). If a particle falls out of the airflow and becomes lodged on the inner walls 812, 814, 816 of the impact collector 800, the lodged particle may appear in subsequently collected airflows that do not include particles of a material of interest. The lodged particle may fall into such an airflow, land on the sample collector, and result in a false positive. To help minimize these effects of particles falling out of the airflow, there may be a clearing purge cycle after each collection of air from the region of interest in which the system is run without additional sample material.

In the impact collector 800, the end of the sample tube may be close coupled to the sample collector 735. The sample collector 735 may be constructed from, for example, floropolymer such as PFA (perfluoroalkoxy), stainless steel mesh, carbon fiber, or a deactivated glass wool pad. To determine whether the particles collected on the sample collector 735 include particles of materials of interest, the sample collector 735 may be heated and the release of energy from the sample collector monitored and analyzed for the presence of thermal signatures having characteristics of thermal signatures of explosives. If resistive heating is used to heat the sample collector 735, the sample collector 735 is made from a material that is at least partially electrically conductive. If radiative heating is used to heat the sample collector 735, the sample collector 735 may be made of a thermally conductive material that absorbs heat but that is not necessarily electrically conductive.

In the impact collector 800, the air and explosive vapors divide according to the ratio of the bypass flow to the collector flow. Typical collector flows are between 0 and 10 percent of the total flow. Particles, however, are not able to make the 180° turn. Thus, particles land on the sample collector 735. The internal inner diameter 816 of the impact collector 800 is about 1.5 cm, and the outer ring 840 is about 3 cm in diameter. If the sample collector 720 rotates, the impact collector 800 itself needs to clear the sample collector 735. The impact collector 800 may seal against the portion of the sample collector 735 at the outer ring with the inner tube being from about 0.2-2.0 cm away from the sample collector 720. An O-ring may be included on the outer tube 850 to form a seal between the sample collector 720. In come cases, slight leakage may be acceptable. Depending on implementation, either the impact collector 800 is lowered to form the seal, or the sample collector 720 is raised to form the seal. Another example implementation of an impact collector is discussed in U.S. patent application Ser. No. 12/047,052, which is herein incorporated by reference in its entirety.

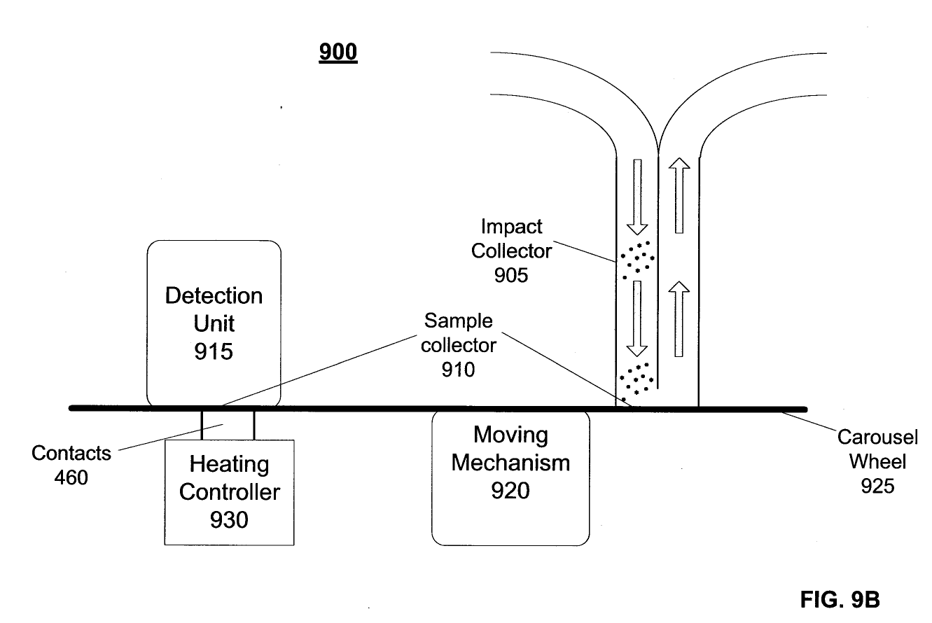

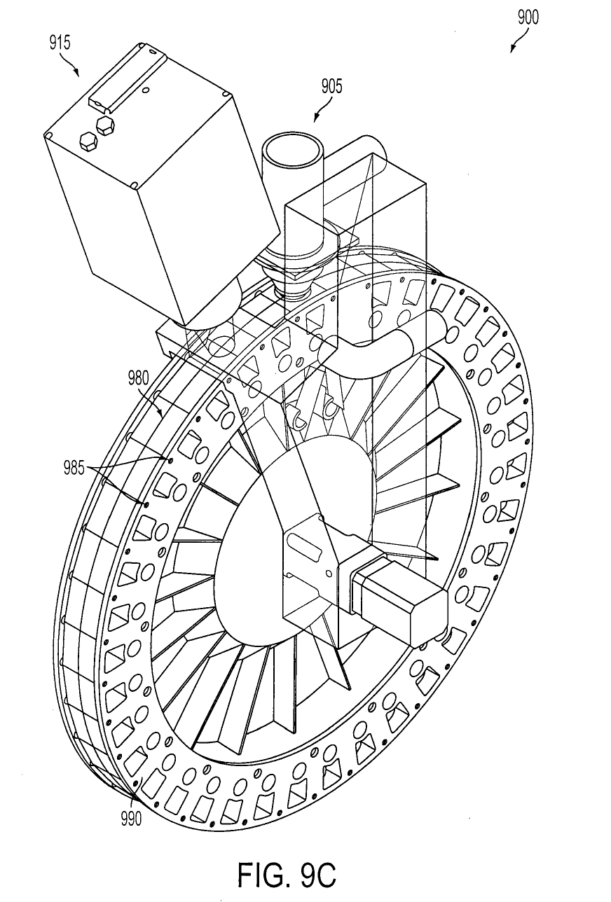

FIGS. 9A-9C illustrate an example of a collection and detection system 900. In particular, FIGS. 9A and 9B illustrate an implementation that uses a carousel wheel with a reusable collection surface. In some implementations, a reel-to-reel system may be used. A reel-to-reel system may be more expensive to build and maintain as compared to a carousel system, but the reel-to-reel system also may hold more collection material such that the time between replacement of the collection surface may be greater.

Referring to FIG. 9A, a top view of a sample collection and detection system 900 is shown. The system 900 includes an impact collector 905, a collection surface 910, and a thermal decomposition system 915. The impact collector 905 may be the impact collector 800, and the collection surface 910 may be the sample collector 735, each of which are discussed with respect to FIG. 8. The thermal decomposition system 915 may be a system such as the system 1000 discussed below with respect to FIG. 10.

In the system 900, the impact collector 905 deposits samples onto the collection surface 910. A moving device 920 (shown in FIG. 9B) moves the collection surface 910, which is mounted on a carousel wheel 925, such that the collection surface 910, moves from a region adjacent to the impact collector 905 to a region within the thermal decomposition system 915. The samples deposited on the collection surface 910 are then analyzed to determine whether the samples on the collection surface 910 include trace amounts of energetic materials.

Referring to FIG. 9B, a side view of the collection and detection system 900 is shown. In particular, a heating controller 930 is shown. The discussion below refers to two example implementations that use resistive and radiative heating to heat the sample collector 910 such that thermal decomposition of samples on the sample collector 910 is triggered. However, other methods of initiating thermal decomposition may be used. For example, the temperature of the samples may be increased using any type of electromagnetic radiation, convention to heat the sample using warm air, and/or the sample may be heated using conduction.

In the system illustrated in FIG. 9B, the sample collector 910 is within the carousel wheel 925, and the sample collector 910 includes either a series of discreet collecting areas or a continuous collection area. In a series of steps, the collection and detection system 915 gathers collected samples onto an area of the sample collector 910. The detection system 900 rotates the carousel wheel 925 to allow the deposited samples to be analyzed for the presence of energetic materials (such as explosives). In one implementation, the heat released from the sample collector 910 is measured to determine whether energetic materials are present. Explosive compounds decompose exothermically (they release heat to the surroundings) when heated anaerobically. A detector senses the thermal energy released during exothermic decomposition, which has thermodynamic properties unique to energetic materials. This feature makes it possible to detect the presence explosives, including nitro-organics and nitro-salts, peroxides, perchlorates, and gun powder, as well as homemade explosives of as yet unknown composition.

The carousel wheel 925 includes “stations,” which refer to specific locations or degrees of rotation of the carousel wheel 925. A first station on the carousel wheel 925 is the impact collector 900, which may be sealed to the carousel wheel 925. The positions of the stations may be determined by the position of holes along the circumference of the carousel wheel 925. After particles are deposited onto the sample collector 910 using the impact collector 800, the carousel wheel 925 rotates to a second station, which detection unit 915.

A moving mechanism 920 rotates the sample collector 910, and in the implementation discussed above, the carousel wheel 925. A stepper motor or a DC motor (either unidirectional or bidirectional) may be used to move the carousel wheel 925. An optical sensor (not shown) may be used to determine and control the position of the moving mechanism 920.

In one implementation that heats the sample collector 910 using resistive heating, the sample collector 910 has an area of three square-centimeters, and the sample collector 910 includes two contacts that are placed at opposite ends of the sample collector 910. The contacts may be shaped in various ways, such as, for example, raised metallic contacts, rods, or plates. A spring loaded contact may be used to complete the connection. The carousel wheel 925 may have an upper half and a lower half. In one assembly method, the upper half and the lower half are separated, the sample collector 910 is installed on the lower half, and the upper half is attached on top of the sample collector 910. In one implementation, for each portion of the sample collector 910, one of the contacts is in the form of an electrode that is coupled to a common connection point (not shown), and the other contact is a separate connection. In such an implementation, the common connection point is constantly connected to the power supply, and the separate connection is selectively connected to the power supply, which allows only one portion of the sample collector 910 to be resistively heated at a time. The sample collector 910 may include openings to hold the optical sensors.

Residual material, such as oils, may contaminate or mask later measurements, or may shorten the life of a reusable sample collector 910. By heating the sample collector 910 to a higher temperature than that required to trigger decomposition of energetic material, such residual material may be burned off to clean the sample collector 910. For example, temperatures in excess of 300° C. may be applied in order to thermally decompose remaining particles such that they are removed from the sample collector 910.

A pyrometer (not shown) may be included in the detection unit 915 or the heating controller 930. During heating, there is slight expansion of the sample collector 910. In order to prevent distortion, the sample collector 910 may be designed such that there is a slight tension on the sample collector 910.

Referring to FIG. 9C, a continuous collection material system 900 includes a continuous conductive collection surface 980, and discrete contact points 985. In the system 900, the continuous material 980 is wrapped around the circumference of a wheel 990. A portion of the continuous material 980 is within the impact collector 905 such that samples may be deposited on the continuous material 980. As the wheel 990 rotates, the continuous material 980 moves within the thermal decomposition system 915.

An electrical connection is established between the continuous material 980 and a heating mechanism through the discrete contact points 985. When the thermal decomposition system 915 is activated, discrete contact points 985 supply a current through the continuous material 980, thus resistively heating the samples on the continuous material 980. In order to prevent an electrical path through the full circumference of the continuous material 980, a portion of the continuous material 980 may be insulated or severed such that the continuous material 980 does not form a complete loop. In other implementations, the continuous material 980 may be coated with a metal, such as nickel, and the continuous material 980 may be sandwiched between two strips of plastic that are wrapped around the wheel 990. The upper strip of plastic may have regularly spaced circular holes and slits between the holes. Electrodes mounted below the detection system 915 may be lowered to make contact with the continuous material 980 in order to supply a current to the continuous material 980.

Referring to FIG. 10, an example system 1000 may be used to determine if explosives are present in a sample collector 1010. The example system 1000 includes the sample collector 1010, an energy supply 1020, a thermal detector 1030, a thermal signature analysis component 1040, and an input/output device 1050.

The sample collector 1010 may be a electrically and/or thermally conductive material on which explosive samples may be collected or harvested, and the sample collector 1010 may be similar to the sample collector 720 discussed above. The sample collector 1010 may be, for example, foil, a metal mesh, or a carbon weave. The energy supply 1020 supplies energy to the sample collector 1010 and any explosive samples present on the sample collector 1010. For example, the energy supply 1020 may supply sufficient activation energy to initiate thermal decomposition (e.g., an explosion) of samples present on the sample collector 1010. The energy supply may heat the sample collector 1010 to, for example, 300° C. in less than one second. The thermal detector 1030 may be, for example, an infrared detector that detects radiant energy released from any samples on the sample collector 1010. The thermal detector 1030 may be one of the infrared detectors described above. In some implementations, the thermal detector 1030 may convert the detected radiant energy into temperature based on a predetermined calibration. The system 1000 also includes a thermal signature analysis component 1040, which may implement one or more processes configured to determine whether explosives are present on the sample collector 1010. The thermal signature analysis component 1040 includes a computer-readable medium configured to store instructions that, when executed, analyze a thermal signature of the sample collector 1010 to determine whether the thermal signature includes characteristics of a signature of an explosive material. For example, the thermal signature analysis component may analyze the thermal signature of the sample collector 1010 for the presence of rapid increase in the thermal energy released from the sample collector 1010 followed by a rapid decrease in the thermal energy released from the sample collector. The thermal signature analysis component 1040 also includes a processor and a storage device.

The system 1000 also includes an input and output device 1050. The input and output device 1050 may include a receptacle for receiving the sample collector 1010, a printer, a touchscreen for selecting commands for the system 1000, and/or any other type of input/output device for communicating with the system 1000.

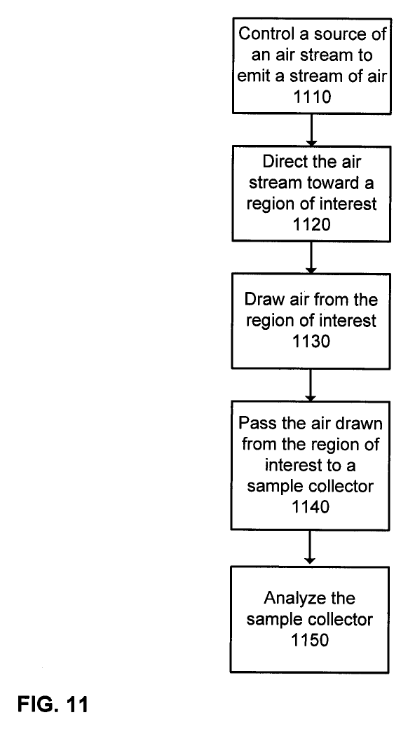

Referring to FIG. 11, an example process 1100 may be used to determine whether materials on an object within a region of interest are particles of a material of interest. The example process 1100 may be performed by a system such as the system 500 discussed above with respect to FIG. 5.

A source of an air stream is controlled such that the source emits a stream of air (1110) toward a region of interest. The air stream may be controlled by opening the flow device 520 to release the air stream toward the region of interest. Additionally, the flow device 520 may be opened at a particular time and for a particular duration, either of which may be pre-defined or determined in real time in response to motion of an object within the region of interest. For example, the flow device 520 may be opened for 2-3 seconds to release an air stream into the region of interest for 2-3 seconds. In another example, the flow device 520 may be opened in response to the current position of an object within the region of interest as measured by sensors or predicted from data collected by the sensors.

The air stream is directed toward the region of interest (1120). For example, the air stream may be directed by opening the flow device and emitting the air stream through a tapered air horn placed within the housing. In a second example, the air stream may be directed by angling an air horn or vent through which the air stream is emitted upwards as shown in FIG. 4. Air is drawn from the region of interest (1130). Air may be drawn from the region of interest by receiving the air collector 555. The air drawn from the region of interest is passed to a sample collector (1140). The sample collector may be the sample collector 720. Passing the air drawn from the region of interest results in particles that are carried with the air being deposited on the sample collector 720. The sample collector is analyzed (1150). For example, the sample collector may be analyzed for the presence of particles of explosive materials with a system such as the system 1000 discussed above.

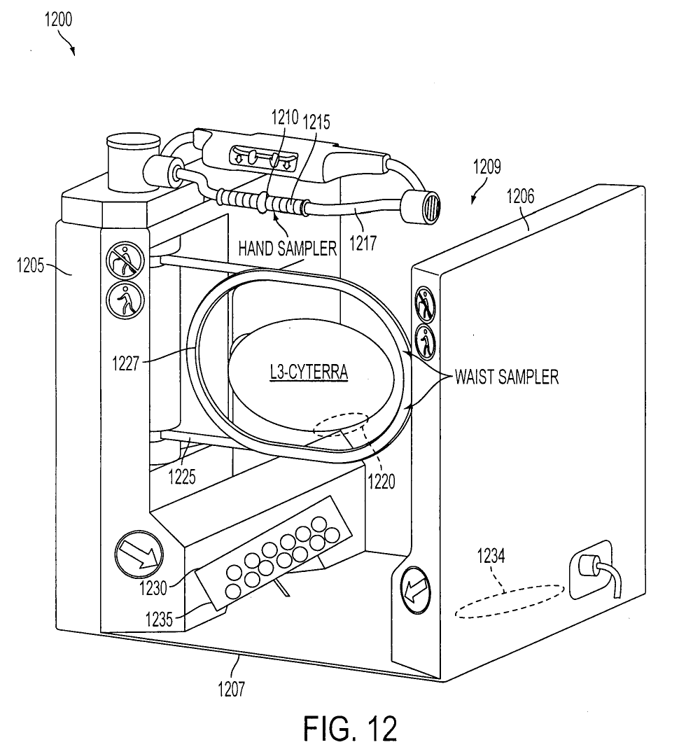

Referring to FIG. 12, an example system 1200 that includes a hand sampler and a waist sampler in addition to a sampler that samples particles from a lower portion of a person is illustrated. The system 1200 includes pedestals 1205 and 1206, an entrance 1207, an exit 1209, a hand sampler 1210, a torso or waist sampler 1227, and a shoe sampler 1230 with sampling techniques directed to each corresponding area of the body. The shoe sampler 1230 may include air sources and air collectors arranged in an array as shown and discussed with respect to FIGS. 1A-4. In the example shown, the shoe sampler 1230 includes an air source 1234 and an array of air collectors 1235.

In the system 1200, passengers traverse a passage that is defined by the pedestals 1205 and 1206. The passage also may be referred to as a region of interest. The passage includes an entrance 1207, a walkthrough space including the samplers 1210-1230, and an exit 1209. The entrance 1207 or exit 1209 from the passage is indicated by the motion of the hand and torso samplers 1210 and 1220. Each of the samplers 1210-1230 includes collection holes which draw in materials such as explosive particles for analysis. Each of the samplers 1210-1230 may also include an associated movement or action designed to increase the number of particles that will be gathered. With sufficient pressure and shear force, explosive particles are dislodged from the hand, torso, or shoe areas. In particular, the hand and torso samplers 1210 and 1220 dislodge and collect samples of material through contact, and the shoe sampler employs a directional air stream to dislodge particles from pants, cuffs, and shoes, and push the particles to the shoe sampler 1230.

The collection system 1200 may be integrated into a small-profile walkthrough turnstile, as shown in the example of FIG. 12. As a passenger passes through the turnstile, the collection system 1200 automatically screens a passenger's hands, torso, and feet for trace explosives. In the example shown in FIG. 12, the passenger pushes the hand sampler 1210 down to unlock the turnstile gate that includes the torso sampler 1220. When the passenger grasps the hand sampler 1210 at grips 1215, suction in the interior of tube 1217 dislodges particles on the passenger's hands and draws the particles in through the collection holes on the grips 1215 of the hand sampler 1210. In one implementation, the hand sampler 1210 moves parallel to the floor as the passenger grips the hand sampler 1210. In another implementation, the hand-sampler 1210 may move in two motions. Specifically, in the first motion, the handle-bar may traverse 30-90° of a circumference of a circle vertically downward from the position shown in order to rotate the surface area of the grips 1215 with respect to the surface area of the hand(s) pushing down. In the second motion, the handle-sampler 1210 may traverse 60-90° of a circumference of a circle horizontally from the position shown. The first and second motions may occur concurrently or separately.

As the passenger moves through the turnstile, the torso sampler 1220 brushes against the waist/torso area of the passenger, and suction in the interior of tube 1225 dislodges particles from the passenger's waist and draws the particles in through the collection holes 1227 of the waist sampler 1227. In one implementation, the torso sampler 1220 traverses 60-90° of a circumference of a circle horizontally outward from the position shown, similar to the hand sampler 1210. The combination of the movement of the hand and torso samplers 1220 present the entrance 1207 which enables the passenger to traverse the collection system 1200. While the passenger moves and/or traverses the hand and torso samplers 1210 and 1220, the shoe sampler 1230 directs a stream of air from the outlet port 1234 toward one or more of the inlet ports 1235. The outlet port 1234 is shown with a dashed line to indicate that the outlet port is on the side of the pedestal 106 that is hidden from view in FIG. 12. Specifically, the stream of air moves towards the passenger's shoe/pant cuff area to dislodge particles and, with the dislodge particles, is drawn into the shoe sampler 1230 through the inlet ports 1235 that are activated. The hand sampler 1210 and torso sampler 1220 may both be locked closed and only unlock when certain conditions are met. In one implementation, the outlet port 1234 is on the right pedestal 1206, while the inlet ports 1235 are on the left pedestal 1205. The air streams from the samples 1210-1230 are joined inside the pedestal 1205 through “Y” type connections so as to enable the three samplers 1210-1230 to impact on a sample collector such as the sample collector 735 simultaneously.

The collection system 1200 may include a pressure switch on the floor just before the entrance to the turnstile, or a proximity sensor at the entrance to detect the presence of the passenger. A detected presence may control system components, such as, for example, the status of a blower, or the locking or unlocking of the hand and torso samplers 1210 and 1220. Components of the system may be constructed using a variety of materials, such as, but not limited to, aluminum, steel, glass, plastic or composite. Metals such as aluminum or steel may interfere with the operation of standard walk-through metal detectors if they are in close proximity to the collection system 1200. Composite or plastic materials may be used to avoid such interference.

In one implementation, the target sample rate is about 360 passengers per hour (6 passengers per minute) through the system 1200. This rate is determined by three main factors. One factor is the time taken takes by the passenger to pass through the turnstile. The second factor is the analysis time, which includes the time to transport the sample to the analyzer, the time required for analysis of the material, and the time required to calculate results using the data produced by the analyzer. In some implementations, the analysis functions may be operated in a pipelined manner such that, for example, a first sample is analyzed while a second sample is being collected and transported to the analyzer, thereby doubling the throughput of the system 1200. The third factor is one of choreography. For example, if the turnstile is capable of accepting a passenger every five seconds, to maximize efficiency, the passengers need to present themselves to the turnstile in that amount of time.

It is understood that other modifications are within the scope of the claims. For example, the detection system 1000 may be a detection system configured to determine whether the sample collector 1010 includes particles of a narcotic material.

What is claimed is:

1. A system comprising:
air sources each configured to:
direct a stream of air during a sampling period, the directed stream of air being capable of dislodging a particle from an object while the object is moving through a region of interest, and
restrict the stream of air during a restricting period;
air collectors configured to collect air from the region of interest;
a sensor configured to output an indication of a position of the moving object; and
a processor configured to:
determine, based on the output indication, a relative position of the moving object with respect to the region of interest, and
activate fewer than all of the air sources or fewer than all of the air collectors based on the determined position of the moving object with respect to the region of interest.

2. The system of claim 1, wherein the air sources are each configured to direct the stream of air toward the region of interest.

3. The system of claim 1 further comprising a conduit coupled to the air collectors and configured to deposit collected air onto a sample collector.

4. The system of claim 1 further comprising a housing comprising first and second pedestals, wherein the region of interest is defined between the first and second pedestals.

5. The system of claim 1 further comprising a detection apparatus configured to analyze the sample collector for the presence of particles having characteristics of materials of interest.

6. The system of claim 1 further comprising a second sensor configured to output an indication of a size of the moving object, and wherein the processor is further configured to:
determine the size of the moving object based on the indication of the size of the moving object, and
activate fewer than all of the air sources or fewer than all of the air collectors based on the determined size of the moving object.

7. The system of claim 1, wherein:
the indication of position of the moving object comprises an indication of a speed of the moving object, and
the processor is further configured to determine the speed of the moving object based on the indication of the speed of the moving object, and to activate fewer than all of the air sources or fewer than all of the air collectors based on the speed of the moving object.

8. The system of claim 7, wherein the object moves through the region of interest in a direction transverse to a normal of a surface of the first or second housing pedestals that is adjacent to the region of interest.

9. The system of claim 1, wherein the moving object comprises a person, and the region of interest comprises a volume encompassing a lower portion of the person.

10. The system of claim 9, wherein the lower portion of the person comprises a portion of the person below a knee.

11. The system of claim 1, wherein the conduit comprises a pipe having a smooth inner surface.

12. The system of claim 1, further comprising:
a flow device coupled to each of the air sources, the flow device configured to direct an air stream from an air source toward the region of interest when opened and restrict the air stream when closed, and wherein opening the flow device activates the air source; and
a flow device coupled to each of the air collectors, the flow device configured to pass air through an air collector when opened and prevent air from flowing when closed, wherein opening the flow device activates the air collector.

13. The system of claim 1, wherein the detection apparatus is further configured to:
heat the sample collector,
sense thermal energy released from the sample collector while the sample collector is heated,
determine a thermal signature of the sample collector based on the sensed thermal energy, and
analyze the thermal signature for characteristics of explosive materials.

14. The system of claim 1 wherein:
the first housing pedestal encloses the air sources, the air sources are close coupled to the region of interest, and the first housing comprises an opening through which an air stream is directed, and
the second housing pedestal encloses the air collectors, the conduit, and the detection apparatus, the second housing being on an opposite side of the region of interest from the first housing, the air collectors being close coupled to the region of interest, and the second housing comprising an opening through which air is received by the air collectors.

15. The system of claim 1, wherein the air collectors receive air from the region of interest only during a sampling period.

16. The system of 1, wherein:
the air sources are arranged in a two-dimensional array of air sources close coupled to the region of interest, and
the air collectors are arranged in a two-dimensional array of air collectors close coupled to the region of interest.

17. The system of claim 1, wherein the air collector is configured to draw air through a suction force.

18. A method for trace detection, the method comprising:
determining a position of an object moving through a region of interest;
selectively activating, based on the determined position, at least one source of an air stream, the air stream being capable of dislodging a particle from the object moving through the region of interest;
directing the air stream toward the region of interest;
selectively activating, based on the determined position, an air collector to draw air from the region of interest;
depositing the drawn air on a sample collector; and
analyzing the sample collector to determine whether the deposition of the air stream left particles of a material of interest on the sample collector.

19. The method of claim 18, wherein the object in the region of interest comprises a lower leg and foot of a person.

20. The method of claim 18, wherein analyzing the sample collector to determine whether the deposition of the air stream left particles of a material of interest on the sample collector comprises:
heating the sample collector,
sensing thermal energy released from the sample collector while the sample collector is heated,
determining a thermal signature of the sample collector based on the sensed thermal energy, and
analyzing the thermal signature for characteristics of explosive materials.

21. A computer-readable medium encoded with a computer program product comprising instructions that, when executed, operate to cause a computer to perform operations comprising:
determining a position of an object moving through a region of interest;
selectively activating, based on the determined position, at least one source of an air stream, the air stream being capable of dislodging a particle from the object moving through the region of interest;
directing the air stream toward the region of interest;
selectively activating, based on the determined position, an air collector to draw air from the region of interest;
depositing the drawn air on a sample collector; and
analyzing the sample collector to determine whether the deposition of the air stream left particles of a material of interest on the sample collector.
